(19) United States
(12) Patent Application Publication
(10) Pub. No.: US 2002/0014273 A1
(43) Pub. Date: Feb. 7, 2002

(54) Manufacturing process for the pouf/puff

(76) Inventor: Kelly Ann Masterson, Redding, CA (US)

Correspondence Address: Kelly Ann Masterson, 280 Ironwood Lane, Redding, CA, 96003, US

(21) Appl. No.: 09/877,550

(22) Filed: Jun. 8, 2001

Related U.S. Application Data
(60) Provisional application No. 60/209,959, filed on Jun. 8, 2000.

(51) Int. Cl. D03D 3/00; D06N 7/04; B43L 21/00; B32B 1/00; A47K 7/02; A41D 19/00

(52) U.S. Cl. 139/385; 428/152; 2/167; 15/227

(57) ABSTRACT

A method is provided for manufacturing a puff or pouf which is used for bathing. The puff is currently most widely used for bathing purposes however it is not the intent to limit the use for this purpose only as the puff can be used in a multitude of ways. It is the intent to broaden the use of the puff in a multitude of ways both Commercially and Industrially. The puff can be used for bathing, household cleaning and so on.

The material most currently being used is polymeric netting, commonly referred to as extruded scrim.

The method includes stretching the netting(s), one or more, by running a ball through a predetermined length of the tubular form of material to stretch it to a desired width as it is being stitched and/or gathered by machine or hand. This results in a predetermined length of netting which has now been gathered using a formula which will predetermine the size and shape of the puff. The stitching gauge or formula will determine the looseness and or tightness of the wrap the end result being a larger or a smaller puff. The formula being the gauge of the stitching being used for the desired look.

Once the tubular form of netting has been stretched and stitched it now has the look of a “Boa”, an article used in the fashion industry most commonly worn wrapped around ones neck. With the “Boa” achieved the netting can now be scrunched by hand and secured with a dead knot, or by other various means of securing, forming a puff or pouf.

In using this method the size and look of the finished product will be consistent in mass production.

### FIELD OF THE INVENTION

The present invention relates to wash/cleaning pads made of an extruded plastic scrim and are used in a multitude of ways including, but not limited to bathing and/or cleaning. These pads are commonly referred to as “puffs or “Poufs” or by various trademarks such as “Scrubbie and “Bath Ball”TM.

1. BACKGROUND OF THE INVENTION

The puffs used in combination with the present invention are generally round, and typically 6″8″in diameter and are made in an array of colors. Puffs have become very popular in recent years due in part to their ability to quickly generate thick lather and gently, effectively wash a persons skin.

The results of the discoveries of the present invention herein, have broadened, in that by using the new manufacturing process one can achieve their desired size, shape and look of the finished product by using different “Gauges” of stitching. In other words, one can control or choose the necessary gauge to create the desired look.

2. DESCRIPTION OF PRIOR ART

In the past, one manufacturing process requires that the mesh netting, or extruded scrim, be gathered by hand. Another prior art process requires the use of wooden dowels to wrap the material around to form the puff. The final step would be to secure the puff with a dead knot or finishing knot.

These processes have gained popularity and are the most commonly used in the industry.

### SUMMARY OF THE PRESENT INVENTION

The present invention virtually guarantees consistency of the finished products size, shape and look, whereas previously used processes do not.

In using the present invention one would be enabled to pre-stitch material by the roll. One would also have the option of pre-stitching individual lengths of material. Pre-stitching by the roll would be a huge benefit in high volume production.

Another benefit of the present invention would be that less Quality Control would be required as finished product would automatically be consistent in dimension and appearance. The maker would choose the length of material to be used, determine the desired width and decide on the gauge of stitching to be used down the center of the material. This would be the makers individual formula. The formula selected determines the size, shape, density and look of the finished puff.

Example of Formula for Present Invention

10.5 feet in length X 3.5 inches in width.

Pre-stitch down the center of the material with overlap (gather or ruffle or pleat) every 1.5 inches, this being the predetermined “Gauge” of stitching to be used.

You now have a “Boa” meaning a gathered or pleated or ruffled strip of material. This “Boa Effect” can be achieved by any means of stitching down the center of the material, ie, by hand or by machine. It is the intention of this present invention, described and illustrated herein, to include any method or means of creating a “Boa Effect” whether by hand, or machine, or any other means.

It is also the object of the present invention to take in the full scope of formulas, which achieve a desired size, shape and look of the finished product and can be done in virtually any dimensions to achieve a multitude of sizes, shapes, and looks of the finished puff. The use of this formula shall be included in this, the present invention. Again, this predetermined formula and the pre-stitching of the material are used to achieve the desired look of the finished product.

Once you have completed this process, being the new manufacturing process for the puff, referred to as the “Boa” or “Boa Effect” in this writing, you have pre-shaped you puff. The final step would be to wrap or gather the “Boa” and secure with your dead knot or finishing knot as in prior art to complete your puff.

Also, it is the object of the present invention to illustrate all potential attributes singularly and in combination, however, due to the tremendous variations on formulas which can create different appearances of the finished puff, or puff product combination that only the dimensions used to explain the new manufacturing process of the puff, as previously written herein, shall be used hereafter to illustrate the present invention. The present invention would include one or more layers of materials, ie, but not specifically, the combination of two or more colors of materials.

The following would be some, but not all, of the benefits of the New Manufacturing Process for the Puff.

Less Manual Labor

Guaranteed Consistency of Finished Product

Less Quality Control Required

More Cost Efficient

### BRIEF DESCRIPTION OF DRAWINGS

FIG. 1 Top view of prior art mesh netting in tubular form.

FIG. 2 Thread

FIG. 3 Thread FIG. 2, and sewing needle

FIG. 4 Thread FIG. 2, and sewing machine needle

FIG. 5 Pre-cut length of mesh netting

FIG. 6 Thread, FIG. 2, sewing needle FIG. 3

FIG. 7 Front view of FIG. 5 being hand stitched and gathered using thread of FIG. 2, and FIG. 3 sewing needle.

FIG. 8 Top view of FIG. 5, pre-cut length of mesh netting, pre-stitched (gathered) using FIG. 2, thread and FIG. 3 sewing needle creating the “Boa” or “Boa Effect” or the Present Invention described and illustrated herein.

FIG. 9 Netting secured by dead knot or finishing knot.

FIG. 10 Completed Puff

### DETAILED DESCRIPTION OF THE DRAWINGS

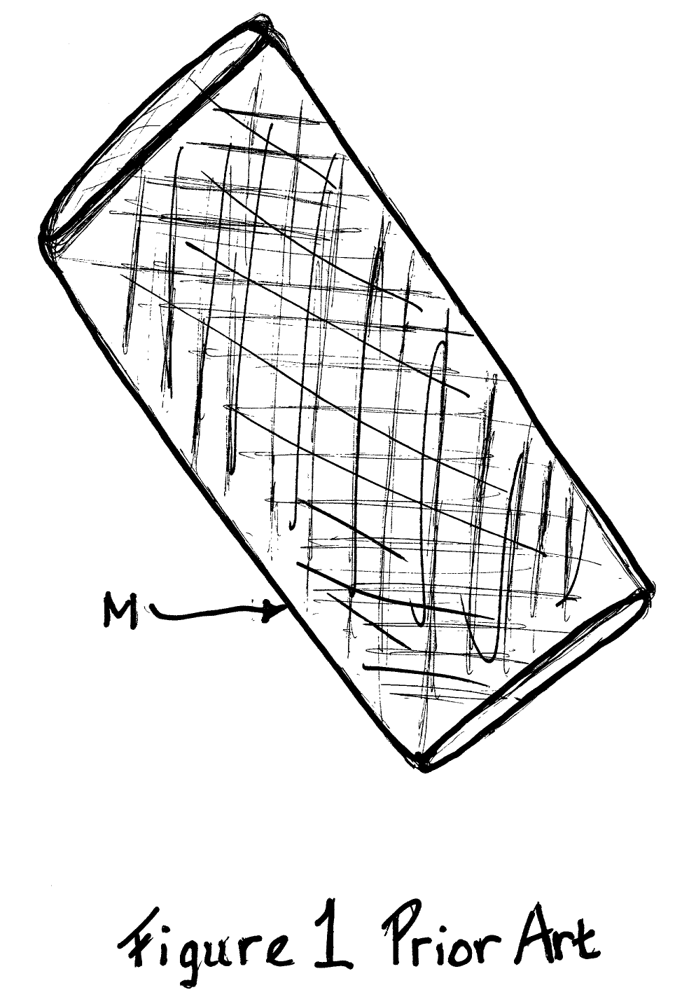

Referring to FIG. 1, this is a prior art drawing of M, Mesh Netting (extruded scrim) shown in its raw form as it comes off of the roll in a tubular form.

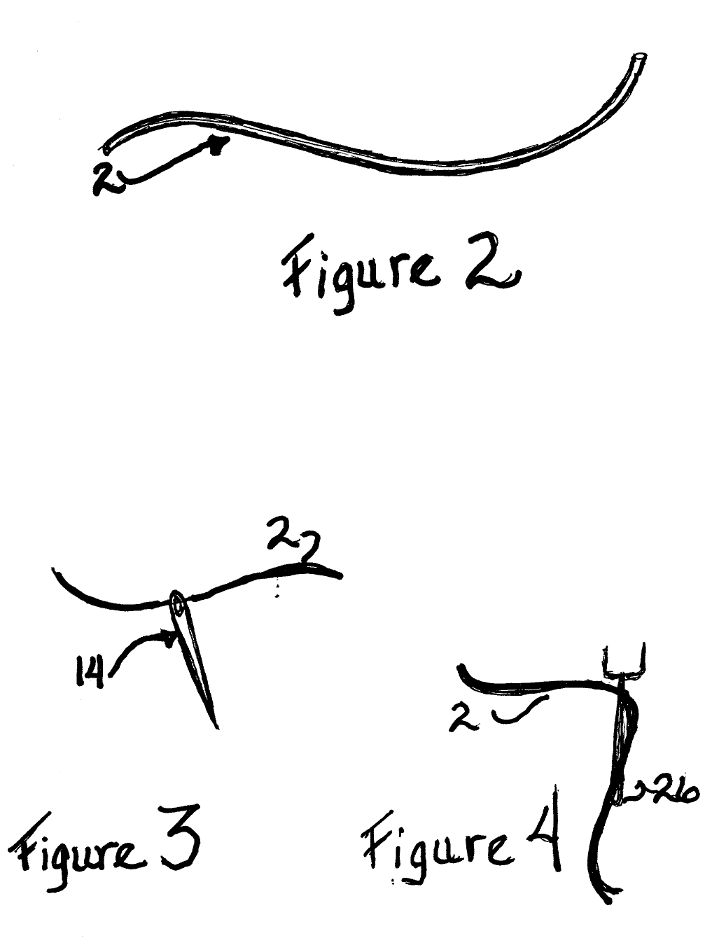

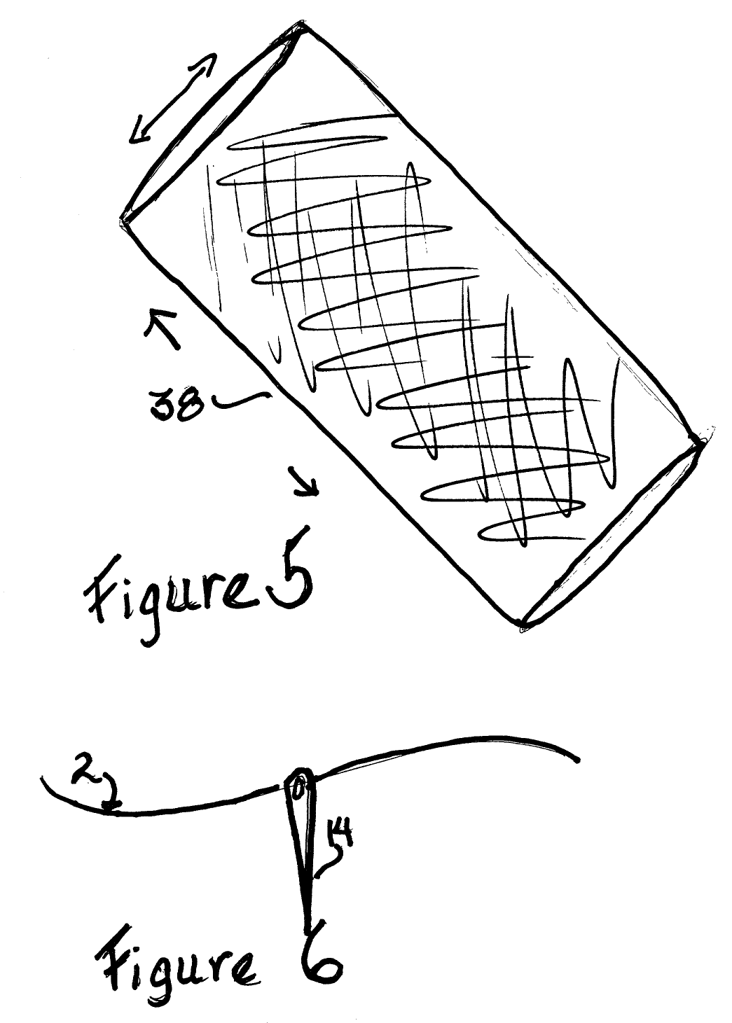

In FIG. 2, 2, sewing thread or cord which is to be used in the new manufacturing process of the puff, prior art P, in combination with either 14, the sewing needle of FIG. 3, or 26 sewing machine needle shown in FIG. 4, as the new manufacturing process can be done either by hand or machine stitching, or any other means to gather material.

FIG. 5, 38, illustrates M prior art mesh netting or extruded scrim cut into a predetermined length and stretched to a predetermined width and is now ready for new manufacturing process to begin.

In FIG. 6 you see 2, sewing thread or cord combined with 14, sewing needle. This illustrates that the method of hand stitching shall be used to accomplish the new manufacturing process for P, the puff, 40 the “Boa”.

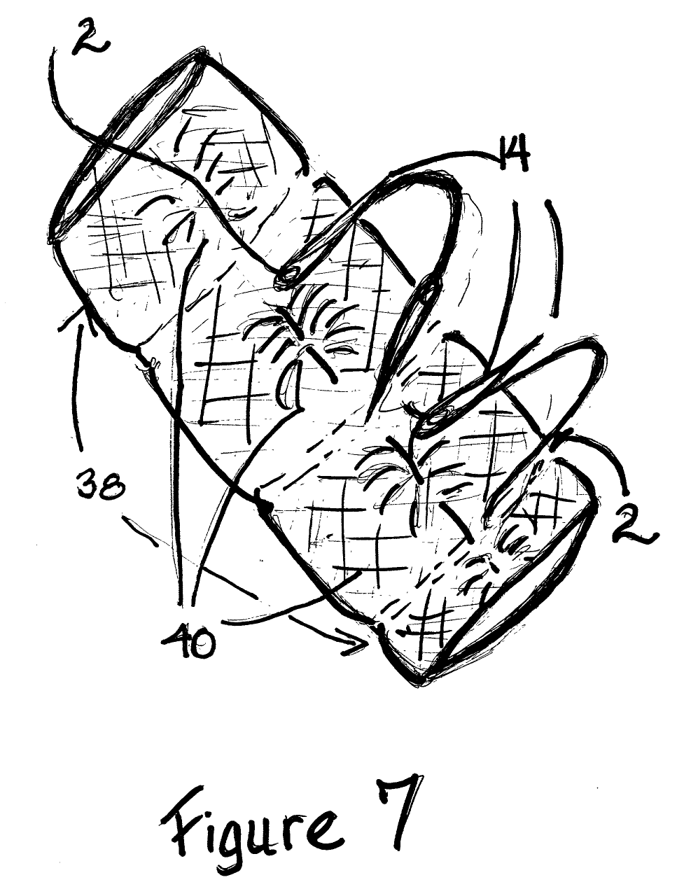

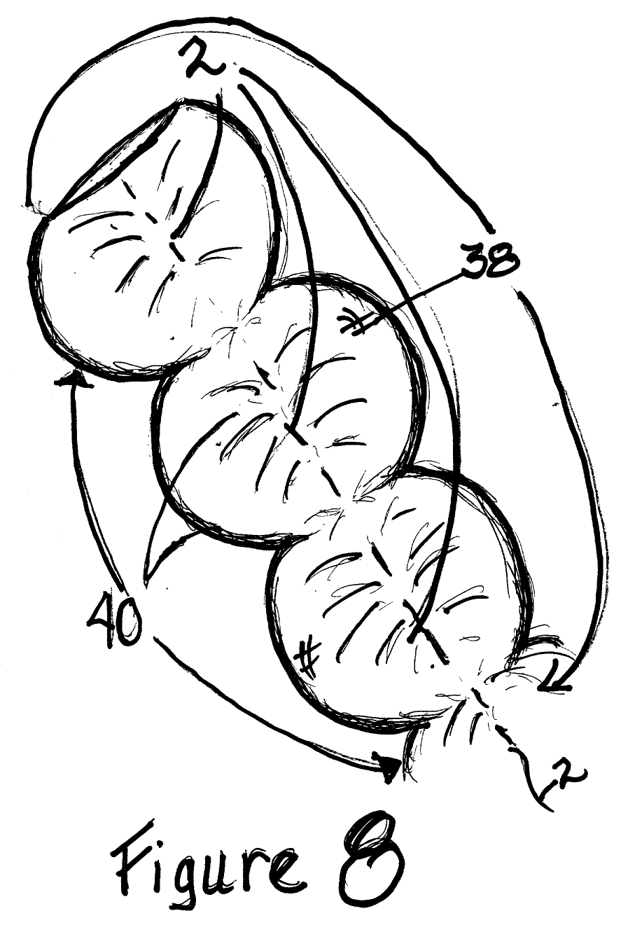

FIG. 7 illustrates for you the present invention, or the new manufacturing process for the puff. It shows front view of M, which has been replaced by 38, with 2 being used in combination with 14 to pre-stitch 38 and create the present invention, 40 the “Boa” or “Boa Effect”. As 14 pulls 2 through 38 in determined gauge or frequency, 38 is transformed into a new form, 40, the “Boa”.

Referring to FIG. 8, you will see 2 holding into place the gathers, or ruffles of 38 creating 40, the “Boa”, this being the present invention.

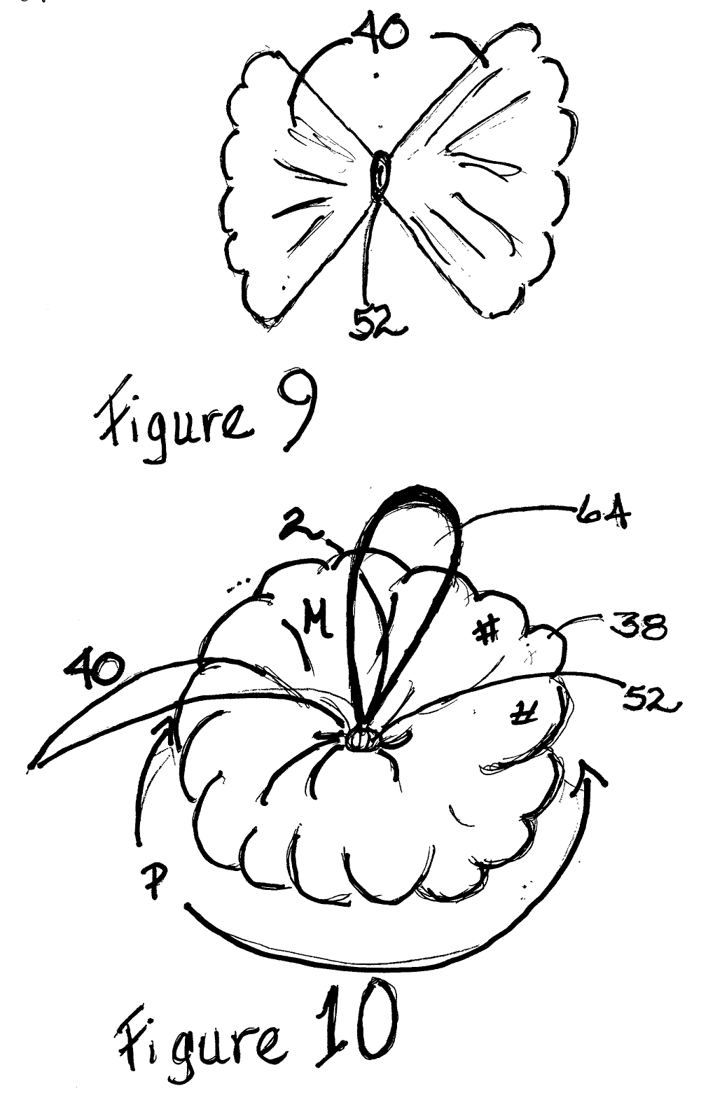

FIG. 9, the final step of production illustrates for you 40, the Boa, or present invention being secured by K, prior art finishing knot.

FIG. 10 Shows finished P, puff created by using the new manufacturing process for P, puff, 40, the Boa. 64, the hang chord has been added to 52, the finishing knot securing 40 the Boa for hanging purposes and is optional. 38 was used to create 40 and 2 was used to hold overlaps (gathers, ruffles or pleats) in place creating 40, this being the present invention, the new manufacturing process for the puff.

What is claimed and desired to be secured by United States Letters Patent is:

1. A process for the manufacture for net Puff/Pouf, said process comprising the steps of: running a ball of predetermined size through a netting tube or tubes to establish desire width while gathering/stitching the nettings by hand or machine using a predetermined formula to achieve desired size, shape and wrap of finished product while doing so creating a “boa effect” of the tubular netting scrunching the net boa by hand and securing with a dead knot or other means of securing forming a net puff/pouf round in shape of a predetermined size and wrap which will be consistent in size and shape when mass produced and more cost efficient as less manual labor will be required and less time will be required using this process in mass production.

2. A process as claimed in claim 1 wherein said tubular netting(s) shall be precut using a predetermined length and have a round ball run through it (the size of the ball depends on the desired width of the finished product, generally a 29 mm ball would be used) while at the same time being stitched and gathered by hand or machine using a predetermined formula.

3. A process as claimed in claim 1 wherein said netting will now be in a “Boa form” of a predetermined length and width.

4. A process as claimed in claim 3 wherein a predetermined formula will be used for the gauge and stitching of the netting to form the boa.

5. A process as claimed in claim 4 wherein a formula will be used to determine the desired size and shape of the finished product.

6. A process as claimed in claim 5 wherein a formula is used which will guarantee the consistency of size and shape of finished product during mass production.

7. A process as claimed in claim 6 wherein said process of using formula to create boa effect will be more cost efficient.

8. A process as claimed in claim 6 wherein using a formula to create said boa effect will be more time efficient.

9. A process as claimed in claim 8 wherein process will be time efficient as it requires less manual labor.

10. A process as claimed in claim 9 wherein process requires less manual labor as puff in boa form can be scrunched and hand tied or secured by one person.

11. A process as claimed in claim 6 wherein the finished size, shape, and look of the product can be controlled by the formula used for the stitching and gathering of the netting(s).

12. A process as claimed in claim 3 wherein the boa effect is created allowing the nettings now in the boa form to be transported to other locations for the final steps of scrunching and securing the puff/pouf.

13. A process as claimed in claim 6 wherein a formula is used giving the manufacturer the freedom of choice on size and shape of the finished product.

14. A process as claimed in claim 1 wherein a ball is used to run through the nettings which will determine the width of the finished product.
